(19) United States
(12) Patent Application Publication
(10) Pub. No.: US 2010/0116102 A1
(43) Pub. Date: May 13, 2010

(54) TORQUE WRENCH WITH MULTIPLE SELECTABLE FUNCTIONS

(75) Inventor: Frederic Genestout, Milan (IT)

Correspondence Address: HEDMAN & COSTIGAN P.C., 1185 AVENUE OF THE AMERICAS, NEW YORK, NY, 10036, US

(73) Assignee: ATLAS COPCO BLM S.R.L., PADERNO DUGNANO (IT)

(21) Appl. No.: 12/450,923

(22) PCT Filed: Apr. 14, 2008
(86) PCT No.: PCT/EP2008/002943

§ 371 Date: Nov. 12, 2009

(30) Foreign Application Priority Data
Apr. 20, 2007 (IT) MI2007A000828

(51) Int. Cl. B25B 23/14

(52) U.S. Cl. 81/473

(57) ABSTRACT

An electronic torque wrench (10) offers a plurality of selectable functions. It includes a control unit provided with a memory card reader (14) and at least one removable memory card (15) equipped with preset activation codes. The control unit reads the activation codes of the memory card contained in the reading unit and enables the wrench functions selected among the many available ones according to the activation codes stored in the memory card.

This invention is a torque wrench endowed with selective function activation.

There are electronic torque wrenches which can measure the torque value and perform a remarkable variety of tightening functions.

For example some known electronic torque wrenches store the different tightening data in on-board files that are downloaded at set intervals toward the different systems controlling production quality. Besides, the wrenches can be supplied with various types of sensors which can better control and store tightening parameters.

All of these functions can be present and enabled, but sometimes they may be redundant and ineffectual in a customized application, both in the sense of a difficult use and of an unjustified price level increasing in proportion with the offered technology.

On the other hand, it can often be wasteful or unprofitable for the manufacturer himself to produce various torque wrench types according to the different technologies and to store spare stock of an assortment of models that would entail problems of logistics, supply, and servicing.

The general purpose of this invention is to prevent the above-mentioned inconveniencies by creating a torque wrench in which the functions can be enabled or disabled in the easiest and most efficient way, while satisfying users' needs.

To that purpose, according to the invention it has been devised an electronic torque wrench endowed with a plurality of functions suitable to be selectively activated and including a control unit characterized in that the torque wrench comprises a memory card reading unit and at least one removable memory card containing preset activation codes, the control unit reading the activation codes of the memory card inserted in the reading unit and enabling wrench functions selected among the plurality of functions according to the activation codes stored in the memory card.

To better explain the innovative principles of the invention and its advantages compared to the previous known technique, the following lines will illustrate one of the possible achievements based on those principles with the help of drawings. As to the drawings:

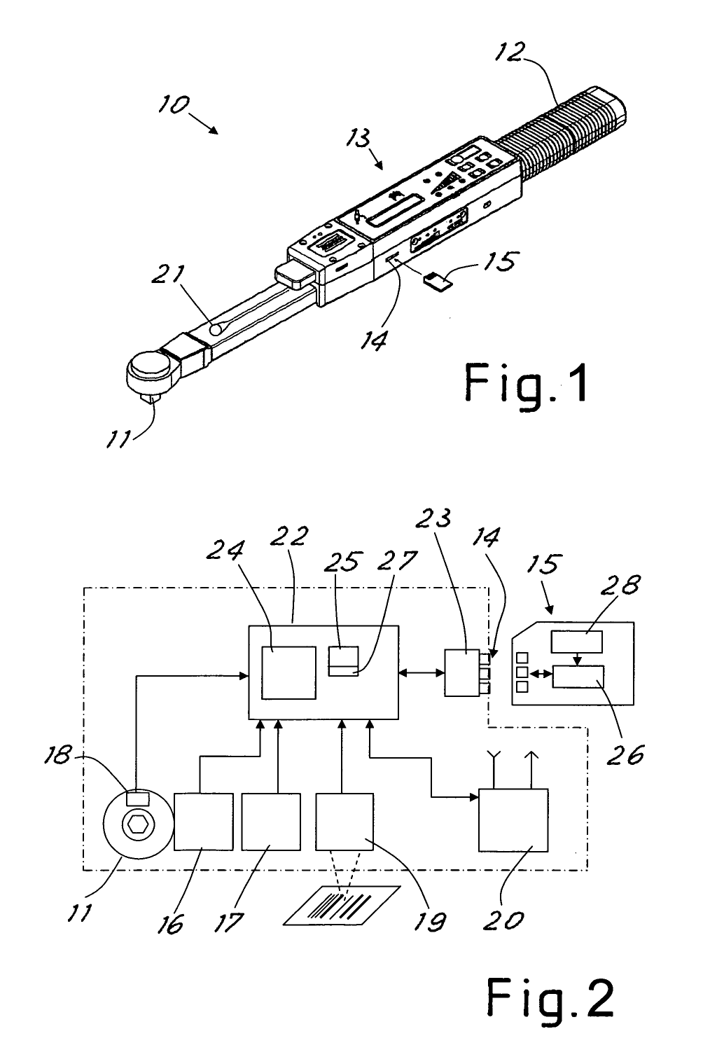

FIG. 1 represents a perspective view of a wrench respecting the invention principles;

FIG. 2 represents a block diagram of the wrench circuit of FIG. 1.

FIG. 1 shows a torque wrench 10 composed by a head 11 with a joint for the tools or bushes to be mounted on the wrench for the various screws to be tightened. The head 11 can be associated to an appropriate ratchet mechanism. The opposite end bears a handle 12. The body 13 houses the wrench functionality electronics; on its surface are the commands and the display devices (LED and screen).

The wrench can have countless functions, each of them already well-known and easy to implement by the technician. In a built-in slot 14 can be inserted a memory card 15 enabling the wrench functions.

As shown in FIG. 2, the front part contains the sensors for torque measuring 16 and angle measuring 17. A tool recognition sensor 18 can also be fitted. The wrench incorporates a barcode reader 19 and a transmission system 20 that, besides including a standard via cable serial port, also uses wireless transmission techniques (generally radio technologies such as 433 MHz or 866 MHz, WI-FI, Blue-tooth, etc.). As shown in FIG. 1, a light source 21 can be embedded to light up the working area.

The electronic torque wrench is thus endowed with a variety of selectively activated functions which use the different wrench sensors and devices individually or in association. The torque wrench includes a control unit 22 connected to the memory card reading unit 23 and integrates at least one removable memory card 24 containing the activation codes preset for these functions. The control unit decodes the memory card activation codes of the reading unit and as a result activates the wrench functions that have been selected among the whole available set.

The control unit incorporates a microprocessor 24 with a basic program memory 25 embedded for wrench functionality. The microprocessor is effectively connected to the reading unit 23 for the implementation of further subprograms stored in the memory card. In this way, it is possible to enhance the wrench by adding features that are not provided by the basic program.

The cost-effective memory card 15 includes protection devices 26 against indiscriminate reading, thus preventing illegal copy of the activation data on a new memory card. The protection devices 26 communicate with the control unit 22, so that it is possible to disable protection during authorized memory card reading by the wrench control unit.

To optimize this particularly beneficial objective, the control unit 22 has been provided with a specific memory location 27 containing an unlock code, while the memory card possesses its own protection control unit 26 controlling reading access to the memory card location 28 and containing the feature activation codes, accessible only after having received a valid unlock code from the wrench control unit. Thanks to this, it is impossible for a copying device to gain access to the memory card data.

The memory cards can be factory preset with the functions to be enabled or programmed by the local torque wrench supplier through a specific programming equipment protected by the unlock code. Here, memory card means any removable storing device and can be based on any known technology, such as SIM, SD, MMC, other memory card standards or purposely created devices.

It is now obvious that the anticipated objectives have been wholly fulfilled. In accordance with the invention principles, it appears more cost-effective both for the manufacturer and for the user to produce an electronic torque wrench potentially able to perform all the functions of the most advanced version and at the same time easy to be programmed with simple and inexpensive means for the implementation of a well determined feature set. The manufacturer's advantage is evident: only one torque wrench model that can be programmed in the most suitable way for the user, but potentially satisfying all kinds of requirements. The user's advantage is also evident: just one torque wrench model, that can be customized and bought in relation to the desired performances, and at the same time flexible and easy to upgrade according to different functions and needs. At the moment of the purchase, the client will spend in proportion to the selected number of functions. A memory card corresponding to those functions is also supplied. This greatly simplifies inventory management, since the only variations concern memory cards, not wrenches (all alike). Memory cards can be programmed at the client's request by the salesman himself during order processing or during installation, so they can also be stored in an undifferentiated way.

If the user's needs change, he will just have to buy new memory card with the equivalent functions, while the wrench will be the same and no further expenses will be expected.

Of course, the above description of a project based on the pioneering principles of this invention is just an example of such innovation and it is not to be taken as a limitation of the patent rights claimed here.

1. Electronic torque wrench (10) endowed with a plurality of functions suitable to be selectively activated and including a control unit (22) characterized in that the torque wrench comprises a memory card reading unit (23) and at least one removable memory card (15) containing preset activation codes, the control unit (22) reading the activation codes of the memory card inserted in the reading unit (23) and enabling wrench functions selected among the plurality of functions according to the activation codes stored in the memory card.

2. Torque wrench according to claim 1, characterized in that the control unit (22) comprises a microprocessor (24) with a basic program memory (25) and connected to the memory card reading unit (23) for the implementation of further subprograms stored in the memory card inserted in the reading unit, so as to furnish additional functions that are not provided by the basic program.

3. Torque wrench according to claim 1, characterized in that the memory card includes protection means (26) against indiscriminate reading, said protection means communicating with the control unit (22), so as to disable protection during authorized memory card reading by the torque wrench control unit.

4. Torque wrench according to claim 3, characterized in that the control unit (22) possesses an inside memory (27) in which is stored an unlock code, while the memory card possesses its own control unit (26) giving access to the activation codes (28), so that the reading unit can start reading only after receiving the unlock code from the wrench control unit.

5. Torque wrench according to claim 1, characterized in that the torque wrench comprises torque measuring sensors (16), rotation angle measuring sensors (17), recognition sensors (18) of a tool inserted on the wrench, barcode reader (19), wireless transmission system (20) of measuring data, and in that the activation codes can enable functions that use, individually or in association, said sensors, the reader and the transmission system.
